(19) United States
(12) Patent Application Publication
(10) Pub. No.: US 2016/0132332 A1
(43) Pub. Date: May 12, 2016

(54) SIGNAL PROCESSING DEVICE AND METHOD OF PERFORMING A BIT-EXPAND OPERATION

(71) Applicants: Roy GLASNER, Austin, TX (US); Fabrice AIDAN, Austin, TX (US); Aviram AMIR, Austin, TX (US); Noam ESHEL-GOLDMAN, Austin, TX (US); Avi GAL, Austin, TX (US); Ilia MOSKOVICH, Austin, TX (US)

(72) Inventors: ROY GLASNER, KIRYAT ONO (IL); FABRICE AIDAN, RAMAT HASHARON (IL); AMIR AVIRAM, PETACH-TIKVA (IL); NOAM ESHEL-GOLDMAN, TEL-AVIV (IL); AVI GAL, RAANANA (IL); ILIA MOSKOVICH, KIRIAT-GAT (IL)

(73) Assignee: Freescale Semiconductor, Inc., Austin, TX (US)

(21) Appl. No.: 14/898,353

(22) PCT Filed: Jun. 18, 2013
(86) PCT No.: PCT/IB2013/054997

§ 371 Date: Dec. 14, 2015

(51) Int. Cl. G06F 9/30

(52) U.S. Cl. CPC G06F 9/30145; G06F 9/30098

(57) ABSTRACT

A signal processing device comprising at least one control unit arranged to receive at least one bit-expand instruction, decode the received at least one bit-expand instruction, and output at least one control signal in accordance with the received at least one bit-expand instruction. The signal processing device further includes at least one execution unit component arranged to receive at least one source register value comprising at least one data bit to be expanded, extract at least one data bit from the at least one source register value located at an offset position according to the at least one control signal, expand the at least one extracted data bit into at least one multi-bit data type, and output the at least one multi-bit data type to at least one destination register.

### FIELD OF THE INVENTION

This invention relates to a signal processing device and method of performing a bit-expand operation within a signal processing device.

### BACKGROUND OF THE INVENTION

The high data rate for fourth generation (4G) communication technologies, such as LTE (Long Term Evolution), WiMAX, WCDMA (Wideband Code Division Multiple Access) and the like, require complicated operations to be performed on individual bits such as interleaving, descrambling and correlation. These operations consist of extracting individual bits out of the received bitstream, converting the extracted bits into data types that are more efficiently handled by the processor (usually, but not always, bytes or words), and manipulating the data types in different manners.

Performing such extraction of bits into easy-to-use data types in software-only is theoretically very flexible, but it is very inefficient using standard CPUs and DSPs since bit manipulating is usually not directly supported by the instruction set. Performing such extraction of bits into easy-to-use data types using conventional hardware is usually more efficient but not flexible enough to support multiple standards, and less easy to interface with the rest of the implementation which is usually implemented using software.

### SUMMARY OF THE INVENTION

The present invention provides a signal processing device and a method of performing a bit-expand operation within a signal processing device as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates a simplified block diagram of an example of a part of a signal processing device.

FIG. 2 illustrates a simplified block diagram of an example of an execution unit.

FIGS. 3 to 6 illustrate examples of the extraction and expansion of data bits from a source register value to one or more destination register values.

FIG. 7 illustrates a simplified flowchart of an example of a method of performing a bit-expand operation within a signal processing device.

### DETAILED DESCRIPTION OF THE PREFERRED EMBODIMENTS

The present invention will now be described with reference to the accompanying drawings in relation to an example of a signal processing device such as a digital signal processor or the like. However, it will be appreciated that the present invention is not limited to the specific examples herein described and illustrated in the accompanying drawings. Furthermore, because the illustrated embodiments of the present invention may for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

In some examples of a first aspect of the present invention, there is provided a signal processing device comprising at least one control unit arranged to receive at least one bit-expand instruction, decode the received at least one bit-expand instruction, and output at least one control signal in accordance with the received at least one bit-expand instruction. The signal processing device further comprising at least one execution unit component arranged to receive at least one source register value comprising at least one data bit to be expanded, extract at least one data bit from the at least one source register value located at an offset position according to the at least one control signal, expand the at least one extracted data bit into at least one multi-bit data type, and output the at least one multi-bit data type to at least one destination register.

In this manner, by providing the ability to extract data bits from a location within the source register value at a specifiable offset, destructive shift operations of data stored within the source register are not required to be performed in order to locate the data bits to be extracted at a specific location within the source register before they are able to be extracted. This enables the instruction count, cycles, power etc. required for extracting and expanding data bits to be reduced and keeps data within the source register intact for possible other usage.

In some optional examples of the present invention, the at least one bit-expand instruction may comprise at least one offset value, the at least one control unit may be arranged to output at least one control signal comprising an offset control signal corresponding to the at least one offset value of the at least one bit-expand instruction, and the at least one execution unit may be arranged to extract the at least one data bit from the at least one source register value at an offset position according to the offset control signal.

In some optional examples of the present invention, the at least one execution unit may be arranged to extract the at least one data bit from the at least one source register value located at an offset position comprising multiples of a number n of predefined bit steps from an end of the source register value, the multiples of n bit steps being defined by the offset control signal.

In some optional examples of the present invention, the at least one execution unit may be arranged to extract a plurality of data bits from the at least one source register value, expand each of the extracted data bits into at least one multi-bit data type, and output the multi-bit data types to the at least one destination register.

In some optional examples of the present invention, the at least one execution unit may be arranged to arrange the multi-bit data types in order corresponding to the order of the extracted data bits within the at least one source register value, and to output the ordered multi-bit data types to the at least one destination register.

In some optional examples of the present invention, the at least one bit-expand instruction may comprise at least one reverse order flag, the at least one control unit may be arranged to output at least one reverse order control signal corresponding to the at least one reverse order flag of the at least one bit-expand instruction, and the at least one execution unit may be arranged to arrange the multi-bit data types in reverse order corresponding to the order of the extracted data bits within the at least one source register value upon the at least one reverse order control signal comprising a reverse order value.

In some optional examples of the present invention, the at least one bit-expand instruction may comprise at least one extract size value, the at least one control unit may be arranged to output at least one input data size control signal corresponding to the at least one extract size value of the at least one bit-expand instruction, and the at least one execution unit may be arranged to extract a number of data bits from the at least one source register value corresponding to the at least one input data size control signal, expand the extracted data bits into multi-bit data types, and output the multi-bit data types to the at least one destination register.

In some optional examples of the present invention, the at least one execution unit may be arranged to extract a number of data bits comprising at least one of 4 data bits, 8 data bits and 16 data bits from the at least one source register value, expand the extracted data bits into multi-bit data types, and output the multi-bit data types to at least one destination register.

In some optional examples of the present invention, the at least one bit-expand instruction may comprise at least one data type value, the at least one control unit may be arranged to output at least one multi-bit type control signal corresponding to the at least one data type value of the at least one bit-expand instruction, and the at least one execution unit may be arranged to expand the at least one extracted data bit into at least one multi-bit data type corresponding to the at least one multi-bit type control signal, and output the at least one multi-bit data type to the at least one destination register.

In some optional examples of the present invention, the at least one execution unit may be arranged to expand the at least one extracted data bit into at least one multi-bit data type comprising at least one of 8 bits, 16 bits, 20 bits, 32 bits and 40 bits.

In some optional examples of the present invention, the signal processing device may be implemented within an integrated circuit device comprising at least one die within a single integrated circuit package.

In some examples of a second aspect of the present invention, there is provided a method of performing a bit-expand operation within a signal processing device. The method comprises receiving at least one source register value comprising at least one data bit to be expanded, extracting at least one data bit from the at least one source register value located at an offset position according to the at least one control signal, expanding the at least one extracted data bit into at least one multi-bit data type, and outputting the at least one multi-bit data type to at least one destination register.

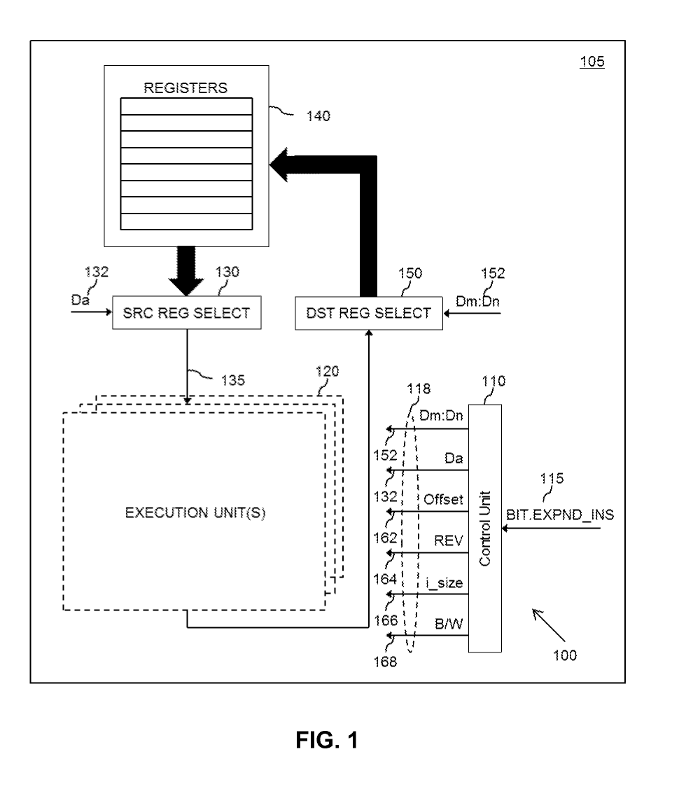

Referring now to FIG. 1, there is illustrated a simplified block diagram of an example of a part of a signal processing device 100. The signal processing device 100 in the illustrated example is implemented within an integrated circuit device 105 comprising at least one die within a single integrated circuit package, and may comprise, for example a digital signal processor (DSP), microprocessor, microcontroller, or other such signal processing device comprising one or more processing cores.

In the illustrated example, the signal processing device 100 comprises one or more control units 110 arranged to receive instructions to be executed, decode the received instructions and output control signals for other components of the signal processing device 100 in accordance with the received instructions. In particular in the illustrated example, at least one control unit 110 of the signal processing device 100 is arranged to receive and decode a bit-expand instruction 115 and output control signals 118 in accordance with the received bit-expand instruction 115.

The signal processing device 100 comprises one or more execution units 120. The execution unit(s) 120 may comprise, for example, one or more arithmetic logic units (ALUs) of the signal processing device 100. The (or each) execution unit 120 is arranged to receive at least one source register value comprising at least one data bit to be expanded, extract at least one data bit from the at least one source register value located at an offset position according to at least one control signal, expand the at least one extracted data bit into at least one multi-bit data type, and output the multi-bit data type(s) to at least one destination register.

In the illustrated example, the signal processing device 100 comprises at least one source register select component 130 arranged to selectively couple the (or each) execution unit 120 to one or more source registers, for example within a register file 140 in the illustrated example, in accordance with a source register address control signal Da 132. The (or each) execution unit 120 is arranged to receive the source register value(s) from the source register(s) selectively coupled thereto by the at least one source register select component 130.

In the illustrated example, the signal processing device 100 further comprises at least one destination register select component 150 arranged to selectively couple the (or each) execution unit 120 to at least one destination register, for example within the register file 140 in the illustrated example, in accordance with a destination register address control signal Dm:Dn 152. The (or each) execution unit 120 is thus arranged to output the multi-bit data type(s) to the at least one destination register selectively coupled thereto by the destination register select component 350.

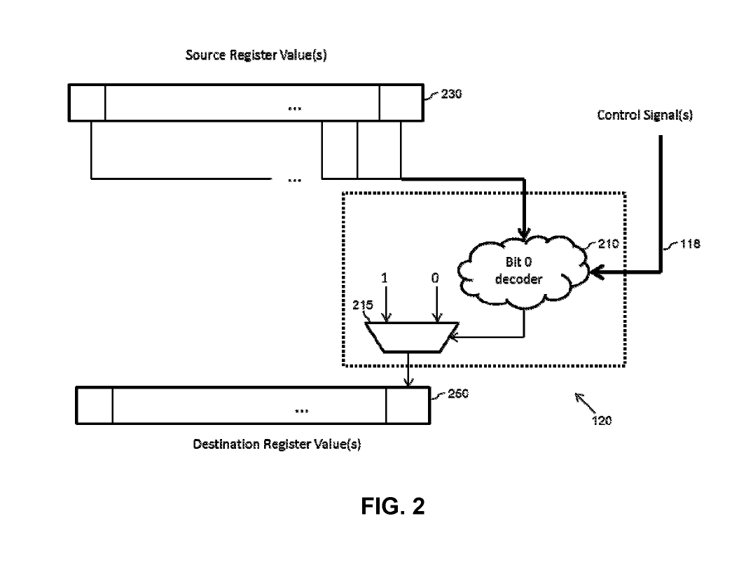

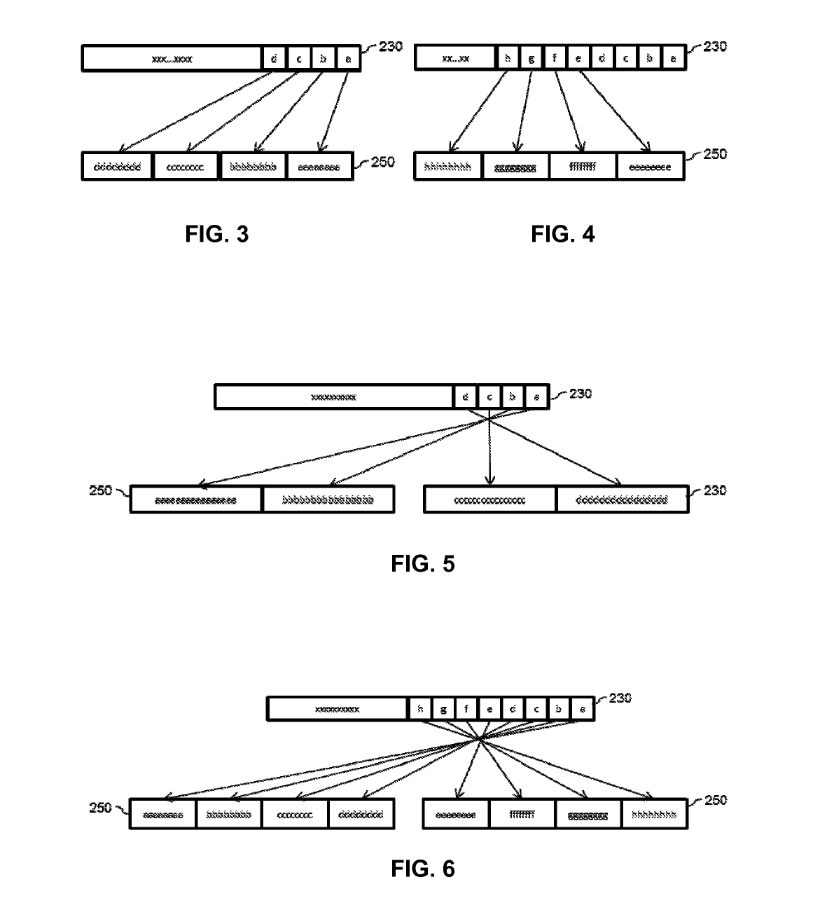

Referring now to FIG. 2, there is illustrated a simplified block diagram of an example of an execution unit 120. The execution unit 120 is arranged to receive a source register value 230, extract at least one data bit from the at least one source register value 230; expand the at least one extracted data bit into at least one multi-bit data type, and output to at least one destination register a destination register value 250 comprising the multi-bit data type(s). In the illustrated example, the execution unit 120 comprises, for each bit within the destination register value 250 to be output, a decoder circuit 210 arranged to receive at least a part of the source register value 230 and at least one control signal 118, and to determine and configure a bit value for the respective bit within the destination register value 250, for example by way of a multiplexer component 215. In particular, the combination of decoder circuits 210 for the multiple bits within the destination register value 250 is arranged such that at least one data bit is extracted from the source register value 230, expanded into at least one multi-bit data type and output to the destination register value 250, for example as described in greater detail below with reference to FIGS. 3 to 6. The decoder circuit 210 for each bit within the destination register value 250 may be implemented in any suitable manner. For example, the decoder circuit 210 may be implemented by way of a simple truth-table with inputs comprising, say, all bit values within the source register value 230 and control signals 118 such as:
a source register address control signal Da 132;
a destination register address control signal Dm:Dn 152;
an offset control signal Offset 162;
a reverse control signal REV 164;
an input data size control signal i_size 166; and
a multi-bit type control signal B/W 168.

In this manner, the combination of decoder circuits 210 for the multiple bits within the destination register value 250, and thus the (or each) execution unit 120 may be arranged to:
extract at least one data bit from the at least one source register value 320 at an offset position according to the offset control signal 162;
arrange the multi-bit data types to be output in reverse order corresponding to the order of the extracted data bits within the source register value 230 upon the reverse order control signal 168 comprising a reverse order value;
extract a number of data bits from the source register value 230 corresponding to the input data size control signal 166, and expand the extracted data bits into multi-bit data types within the destination register value 250; and
expand the extracted data bit(s) into at least one multi-bit data type corresponding to the multi-bit type control signal 168.

FIGS. 3 to 6 illustrate examples of the extraction and expansion of data bits from a source register value 230, to one or more destination register values 250. Referring first to FIG. 3, there is illustrated an example of an extraction of four data bits a, b, c, d from a source register value 230. In the example illustrated in FIG. 3 the four data bits a, b, c, d are extracted from a location within the source register value 230 at an offset of zero, and are each expanded to a multi-bit data type comprising a byte (8-bit) data type, and output to the destination register value 250. As such, a four byte (32-bit) destination register value 250 is output in the example illustrated in FIG. 3, with the four extracted data bits a, b, c, d being expanded into respective byte data types. An example of a bit-expand instruction 115 for the operation of FIG. 3 may comprise:

BIT.EXPND.4B #offset,Da,Dn ; offset=0

Referring next to FIG. 4, there is illustrated an example of an extraction of four data bits e, f, g, h from a source register value 230. In the example illustrated in FIG. 4 the four data bits e, f, g, h are extracted from a location within the source register value 230 at a 4-bit offset, and are each expanded to a multi-bit data type comprising a byte (8-bit) data type, and output to the destination register value 250. As such, a four byte (32-bit) destination register value 250 is output in the example illustrated in FIG. 4, with the four extracted data bits e, f, g, h being expanded into respective byte data types. An example of a bit-expand instruction 115 for the operation of FIG. 4 may comprise:

BIT.EXPND.4B #offset,Da,Dn ; offset=4

Advantageously, by providing the ability to extract data bits from a location within the source register value 230 at a specifiable offset, destructive shift operations of data stored within the source register are not required to be performed in order to locate the data bits to be extracted at a specific location within the source register before they are able to be extracted. This enables the instruction count, cycles, power etc. required for extracting and expanding data bits to be reduced and keeps data within the source register intact for possible other usage.

Referring next to FIG. 5, there is illustrated an example of an extraction of four data bits a, b, c, d from a source register value 230. In the example illustrated in FIG. 5 the four data bits a, b, c, d are extracted from a location within the source register value 230 at an offset of zero, and are each expanded to a multi-bit data type comprising a word (16-bit) data type, and output to the destination register value 250. As such, a four word (64-bit) destination register value 250 is output in the example illustrated in FIG. 5, with the four extracted data bits a, b, c, d being expanded into respective word data types. Additionally in the example illustrated in FIG. 5, the order in which the expanded words are output to the destination register value 250 is reversed. In this manner, reversed endianness extraction is enable, allowing both big and little endian data formats to be supported. An example of a bit-expand instruction 115 for the operation of FIG. 5 may comprise:

BIT.EXPND.REV.4W #offset,Da,Dm:Dn ; offset=0

Referring next to FIG. 6, there is illustrated an example of an extraction of eight data bits a, b, c, d, e, f, g, h from a source register value 230. In the example illustrated in FIG. 5 the eight data bits a, b, c, d, e, f, g, h are extracted from a location within the source register value 230 at an offset of zero, and are each expanded to a multi-bit data type comprising a byte (8-bit) data type, and output to the destination register value 250. As such, an eight byte (64-bit) destination register value 250 is output in the example illustrated in FIG. 5, with the eight extracted data bits a, b, c, d, e, f, g, h being expanded into respective byte data types. Again in the example illustrated in FIG. 6, the order in which the expanded words are output to the destination register value 250 is reversed. An example of a bit-expand instruction 115 for the operation of FIG. 6 may comprise:

BIT.EXPND.REV.8B #offset,Da,Dm:Dn ; offset=0

Referring back to FIG. 1, the (or each) execution unit 120 may be arranged to receive a 32-bit source register value 230 and to extract data bits from the source register value 230 located at offset positions comprising multiples of a number n of predefined bit steps from an end of the source register value 230, the multiples of n bit steps being defined by the offset control signal 162. For example, the (or each) execution unit 120 may be arranged to extract data bits from the source register value 230 located at offset positions comprising, say, multiples of 4 bit steps from an end of the source register value 230. Accordingly, the offset control signal 162 may comprise a multi-bit control signal, for example a 3-bit control signal in this example.

An example of a signal processing device 100 has been illustrated and described in which the signal processing device 100 comprises software controlled circuitry (e.g. controlled by way of the bit-expand instruction 115) that is flexibly controllable to perform a bit expand operation whereby one or more data bits are extracted from a source register value and expanded into at least one multi-bit data type to be output to a destination register.

Advantageously, in the illustrated example, such a bit-expand operation is able to be performed on data located at specifiable offset positions within the source register value. In some examples, such a bit-expand operation is able to be performed on data located at specifiable offset positions across substantially the full width of the source register value, for example at offset positions comprising multiples of a number n of predefined bit steps from an end of the source register value, the multiples of n bit steps being defined by the offset control signal. Advantageously, by providing the ability to extract data bits from a location within the source register value at a specifiable offset, destructive shift operations of data stored within the source register are not required to be performed in order to locate the data bits to be extracted at a specific location within the source register before they are able to be extracted. This enables the instruction count, cycles, power etc. required for extracting and expanding data bits to be reduced and keeps data within the source register intact for possible other usage.

Furthermore, such a software controlled hardware implementation takes advantage of the flexibility of software control to enable multiple standards to be supported, whilst benefitting from the efficiency of hardware execution.

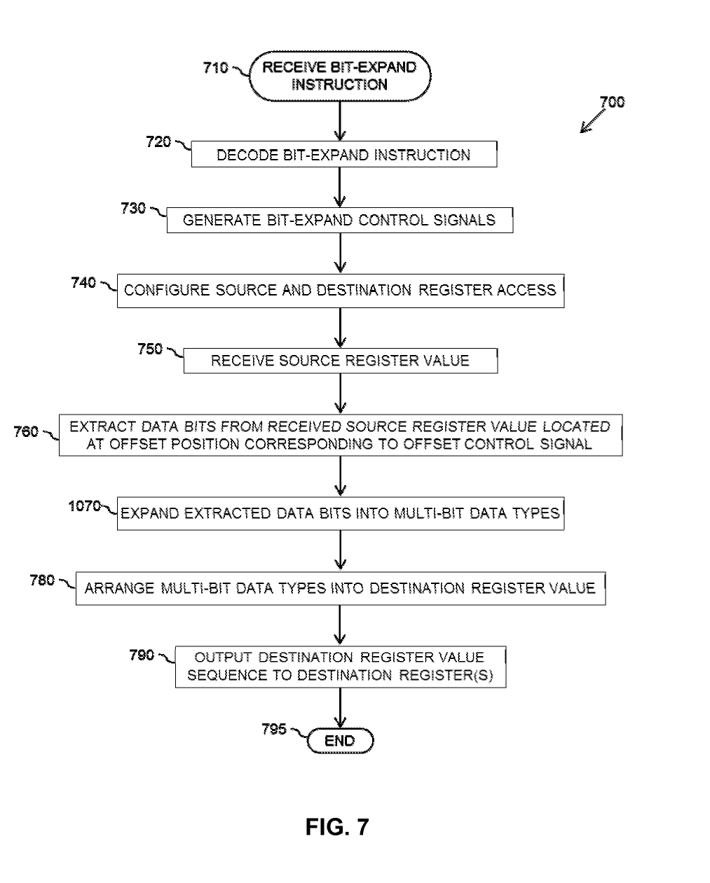

Referring now to FIG. 7, there is illustrated a simplified flowchart 700 of an example of a method of performing a bit-expand operation within a signal processing device. The method starts, at 710 with the receipt of a bit-expand instruction, and moves on to 720 where the received bit-expand instruction is decoded, for example by the control unit 110 illustrated in FIG. 1. Next, at 730, control signals are generated based on the decoded bit-expand instruction. For example, in the example hereinbefore described with reference to the accompanying drawings, the control unit 110 of FIG. 1 may be arranged to generate such control signals comprising one or more of:
a source register address control signal Da 132;
a destination register address control signal Dm:Dn 152;
an offset control signal Offset 162;
a reverse control signal REV 164;
an input data size control signal i_size 166; and
a multi-bit type control signal B/W 168.

Referring back to FIG. 7, access to one or more source register(s) and one or more destination register(s) is then configured, at 740. For example, in the example hereinbefore described with reference to the accompanying drawings, the source register select component 130 of FIG. 1 may configure access to one or more source register(s) by selectively coupling the (or each) execution unit 120 to one or more source registers within the register file 140 in accordance with the source register address control signal Da 132. Similarly, in the example hereinbefore described with reference to the accompanying drawings, the destination register select component 150 may configure access to one or more destination register(s) by selectively coupling the (or each) execution unit 120 to one or more destination registers within the register file 140 in accordance with the destination register address control signal Dm:Dn 152.

Referring back to FIG. 7, the method then moves on to 750 with the receipt of a source register value. Next, at 760, one or more data bits are extracted from the received source register value located at an offset position corresponding to an offset control signal Offset 162. For example, in the example hereinbefore described with reference to the accompanying drawings, the data bit extraction circuit 700 of FIG. 7 is arranged to perform such data bit extraction in accordance with the offset control signal Offset 162.

Referring back to FIG. 7, having extracted the data bit(s) from the received source register value, the method moves on to 770, where the extracted data bit(s) is/are expand into one or more multi-bit data types, and the multi-bit data types are arranged into a destination register value at 780. For example, in the example hereinbefore described with reference to the accompanying drawings, the data bit expansion circuits 800, 900 of FIGS. 8 and 9 are arranged to perform such data bit expansion of extracted data bits and to arrange the resulting multi-bit data types into a destination register value 250 in accordance with the reverse control signal REV 164, input data size control signal i_size 166 and multi-bit type control signal B/W 168.

Referring back to FIG. 7, the destination register value 250 is then output to one or more destination registers, at 790, and the method ends, at 795.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

1. A signal processing device comprising:
at least one control unit arranged to receive at least one bit-expand instruction, decode the received at least one bit-expand instruction, and output at least one control signal in accordance with the received at least one bit-expand instruction; and
at least one execution unit component arranged to:
receive at least one source register value comprising at least one data bit to be expanded,
extract at least one data bit from the at least one source register value located at an offset position according to the at least one control signal,
expand the at least one extracted data bit into at least one multi-bit data type, and
output the at least one multi-bit data type to at least one destination register.

2. The signal processing device of claim 1, wherein:
the at least one bit-expand instruction comprises at least one offset value;
the at least one control unit is arranged to output at least one control signal comprising an offset control signal corresponding to the at least one offset value of the at least one bit-expand instruction; and
the at least one execution unit is arranged to extract the at least one data bit from the at least one source register value at an offset position according to the offset control signal.

3. The signal processing device of claim 2, wherein the at least one execution unit is arranged to extract the at least one data bit from the at least one source register value located at an offset position comprising multiples of a number n of predefined bit steps from an end of the source register value, the multiples of n bit steps being defined by the offset control signal.

4. The signal processing device of claim 1, wherein the at least one execution unit is arranged to:
extract a plurality of data bits from the at least one source register value;
expand each of the extracted data bits into at least one multi-bit data type; and
output the multi-bit data types to the at least one destination register.

5. The signal processing device of claim 4, wherein the at least one execution unit is arranged to arrange the multi-bit data types in order corresponding to the order of the extracted data bits within the at least one source register value, and to output the ordered multi-bit data types to the at least one destination register.

6. The signal processing device of claim 5, wherein:
the at least one bit-expand instruction comprises at least one reverse order flag;
the at least one control unit is arranged to output at least one reverse order control signal corresponding to the at least one reverse order flag of the at least one bit-expand instruction; and
the at least one execution unit is arranged to arrange the multi-bit data types in reverse order corresponding to the order of the extracted data bits within the at least one source register value upon the at least one reverse order control signal comprising a reverse order value.

7. The signal processing device of claim 1, wherein:
the at least one bit-expand instruction comprises at least one extract size value;
the at least one control unit is arranged to output at least one input data size control signal corresponding to the at least one extract size value of the at least one bit-expand instruction; and
the at least one execution unit is arranged to extract a number of data bits from the at least one source register value corresponding to the at least one input data size control signal, expand the extracted data bits into multi-bit data types, and output the multi-bit data types to the at least one destination register.

8. The signal processing device of claim 1, wherein the at least one execution unit is arranged to extract a number of data bits comprising at least one of 4 data bits, 8 data bits and 16 data bits from the at least one source register value, expand the extracted data bits into multi-bit data types, and output the multi-bit data types to at least one destination register.

9. The signal processing device of claim 1, wherein:
the at least one bit-expand instruction comprises at least one data type value;
the at least one control unit is arranged to output at least one multi-bit type control signal corresponding to the at least one data type value of the at least one bit-expand instruction; and
the at least one execution unit is arranged to expand the at least one extracted data bit into at least one multi-bit data type corresponding to the at least one multi-bit type control signal, and output the at least one multi-bit data type to the at least one destination register.

10. The signal processing device of claim 1, wherein the at least one execution unit is arranged to expand the at least one extracted data bit into at least one multi-bit data type comprising at least one of 8 bits, 16 bits, 20 bits, 32 bits and 40 bits.

11. The signal processing device of claim 1 implemented within an integrated circuit device comprising at least one die within a single integrated circuit package.

12. A method of performing a bit-expand operation within a signal processing device, the method comprising:
receiving at least one source register value comprising at least one data bit to be expanded;
extracting at least one data bit from the at least one source register value located at an offset position according to the at least one control signal;
expanding the at least one extracted data bit into at least one multi-bit data type; and
outputting the at least one multi-bit data type to at least one destination register.
